(19) United States
(12) Patent Application Publication
(10) Pub. No.: US 2022/0299158 A1
(43) Pub. Date: Sep. 22, 2022

(54) Compact Tripod as Temporary Marker

(71) Applicant: Emmanuel Linteau, Quebec City (CA)

(72) Inventor: Emmanuel Linteau, Quebec City (CA)

(21) Appl. No.: 17/205,499

(22) Filed: Mar. 18, 2021

(51) Int. Cl. F16M 11/38; E01F 9/688; F16M 11/24

(52) U.S. Cl. CPC F16M 11/38; E01F 9/688; F16M 11/242; F16M 2200/08

(57) ABSTRACT

A compact tripod as temporary marker generally comprising a head coupled to a plurality of legs. The tripod has an extended position and an alternate compact position, thus improving the volume/visibility, weight/volume and weight/visibility ratios. Flexible head enables a multi-angles extended position. Each of the plurality of legs can have one or plurality of segments. The legs segments, if plurality of segments, are coupled by insertion using connector and elastic cord. Each of the plurality of legs is independently foldable from a folded position to an alternate extended position. Each of plurality of feet is coupled to a distal end of one of the plurality of legs.

### CROSS-REFERENCE TO RELATED APPLICATIONS

Non applicable

### STATEMENT REGARDING FEDERALLY SPONSORED RESEARCH

Non applicable

### THE NAMES OF THE PARTIES TO A JOINT RESEARCH AGREEMENT

Non applicable

### STATEMENT REGARDING PRIOR DISCLOSURES BY THE INVENTOR OR A JOINT INVENTOR

Non applicable

### BACKGROUND OF THE INVENTION

### (1) Field of the Invention

This invention relates generally to temporary markers used for, but with no limitation to, traffic on public roads, sporting activities or any warning in general.

### (2) Description of the Related Art Including Information Disclosed Under 37 CFR 1.97 and 37 CFR 1.98

A number of marker devices, such as traffic cones, safety triangles and disc cones are known, with their use being limited either by their weight, volume or visibility. Therefore, a need exists for a robust, compact, light temporary marker with improvement in the volume/visibility, weight/volume and weight/visibility ratios.

### BRIEF SUMMARY OF THE INVENTION

Embodiment of the present invention and disclosure meets the needs presented above by generally comprising a head coupled to a plurality of legs, forming a compact tripod as temporary marker. The tripod has an extended position and an alternate compact position. The flexible head enables a multi-angles extended position and an alternate compact position. Each of the plurality of legs can have one (version with one section only) or plurality of segments (version with plurality of segments). Each of the plurality of legs plurality of segments, if any, is coupled by insertion using connector and elastic cord. Each of the plurality of legs is independently foldable from a folded position to an alternate extended position. Each of plurality of feet is coupled to a distal end of one of the plurality of legs.

In some embodiments, the compact tripod as temporary marker is equipped, or not, with embedded or not, accessories such as hook-and-loop fasteners, sign/panel/poster, lamp/light/led, rod, security tape or the like.

There has thus been outlined, rather, broadly, the more important features of the disclosure in order that the detailed description thereof that follows may be better understood, and in order that the present invention may be better appreciated. There are additional features of the disclosure that will be described hereinafter and which will form the subject matter of the claims appended hereto.

The objects of the disclosure, along with the various features which characterize the disclosure, are pointed out with the particularity in the claims annexed to and forming a part of this disclosure.

### BRIEF DESCRIPTION OF THE SEVERAL VIEWS OF THE DRAWINGS

The disclosure will be better understood when consideration is given to the following detailed description thereof. Such description makes reference to the annexed drawings wherein:

FIG. 1a depicts the tripod (version with legs made of plurality of segments), in its extended position for use;

FIG. 1b depicts the tripod (version with legs made of one segment only), in its extended position for use;

FIG. 2a depicts the tripod (version with legs made of plurality of segments), in its compact storage position with the legs being folded and brought together;

FIG. 2b depicts the tripod (version with legs made of one segment only), in its compact storage position with the legs being brought together;

FIG. 3 depicts the Head of the tripod. The close up depicts the components and protective membrane that make up the Head;

FIG. 4a depicts one of the legs (version made with plurality of segments) of the tripod. The close up depicts the mechanism to fold the leg;

FIG. 4b depicts one of the legs (version made with one segment only) of the tripod.

### DETAILED DESCRIPTION OF THE INVENTION

Markers are used on public roads to warn or direct vehicles, cyclists, pedestrians or others, in order to safely avoid or bypass a vehicle immobilized in the shoulder, a danger, an obstacle or others. Markers are used in sporting activities as an obstacle during training exercises, as a marker to mark the limits of play, as a goal and others. Markers are used in different situations to inform people of danger, risk or others. Current known markers are limited either by their weight, volume, visibility or shape.

The present disclosure describes a marker, generally comprising a head coupled to a plurality of foldable legs, forming a tripod having a multi-angles extended position and an alternate compact position, which can be carried easily and used on multiple surfaces such as a gymnasium floor, grass, asphalt, earth, rocks, snow, sand, ice or any other surface supporting the tripod weight. Embodiment of the present invention improves markers volume/visibility, weight/volume and weight/visibility ratios.

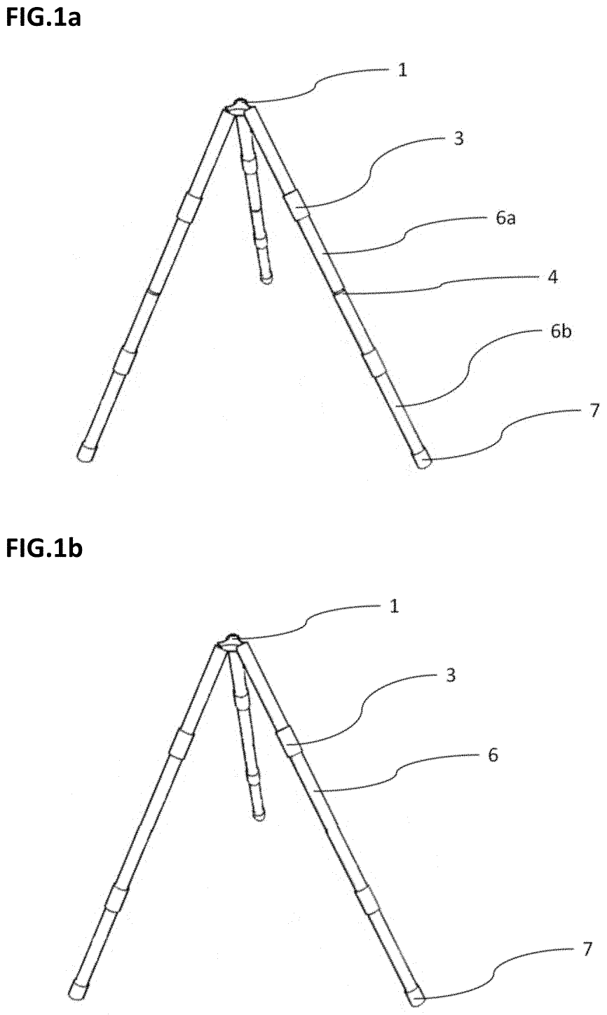

With reference now to the drawings, and in particular to FIGS. 1a to 4b a tripod embodying the principles and concepts of an embodiment of the disclosure and generally designated as the tripod will be describe.

Referring to FIG. 1a the tripod is generally comprising a flexible head 1 coupled to a plurality of legs upper segments 6a;

Referring to FIG. 1b The tripod is generally comprising a flexible head 1 coupled to a plurality of legs segments 6;

Referring to FIG. 1a the tripod, in its extended position for use, has each leg segments (6a and 6b) unfolded, opened and connected. The flexible head 1 enables open multi-angles extended position;

Referring to FIG. 1b the tripod, in its extended position for use, has each leg segments 6 opened and connected. The flexible head 1 enables open multi-angles extended position;

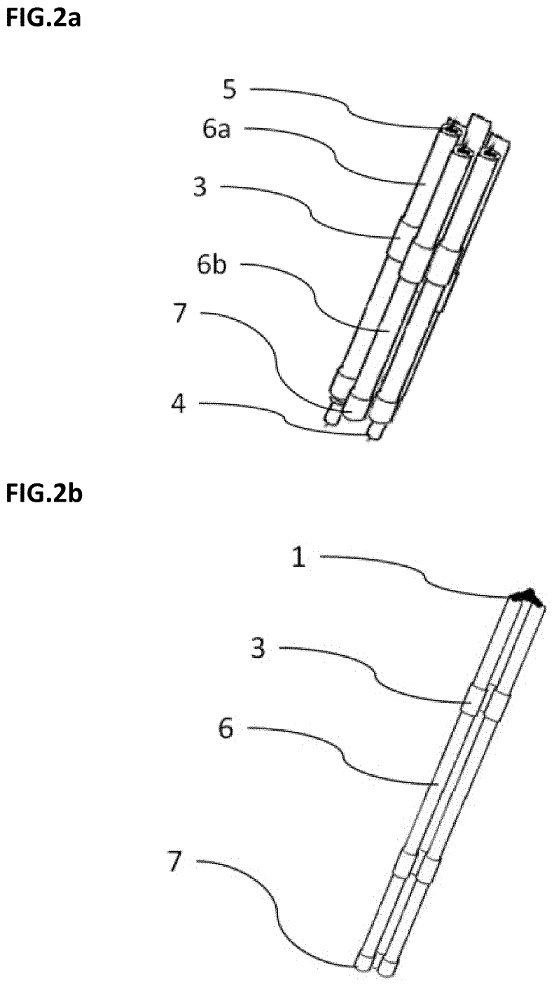

Referring to FIG. 2a the tripod version with legs made of plurality of segments (6a and 6b), in its compact position for storage, has its legs closed by joining them, thanks to the flexible head 1, and folded by pulling and detaching the segments (6a and 6b), thanks to connector 4 and elastic cord 5;

Referring to FIG. 2b the tripod version with legs made of one segment 6 only, in its compact position for storage, has its legs closed by joining them, thanks to the flexible head 1;

Referring to FIGS. 1a, 2a and 4a the tripod version with legs made of plurality of segments (6a and 6b) assembled by a connector 4 and an elastic cord 5, and a foot tip 7;

Referring to FIGS. 1b, 2b, and 4b the tripod version with legs made of one segment only has only one segment 6 and a foot tip 7, but there is neither connector, nor elastic cord, as referred in FIGS. 1a, 2a and 4a;

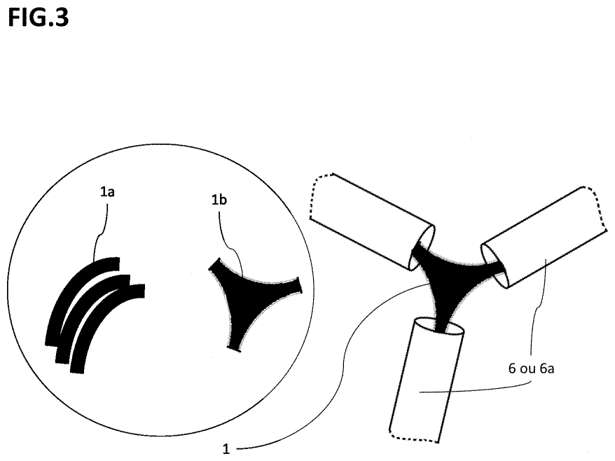

Referring to FIG. 3 the head 1 of the tripod is made up with plurality of flexible parts 1a, joined, inserted and coupled to legs (6a for the tripod version with legs made of plurality of segments or 6 for the tripod version with legs made of one segment only) using or not, without limitation, glue and/or nails 2, then covered with a protective membrane 1b. The flexibility of the head 1 enables closing legs in its compact position for storage and enables multi-angles opening in its extended position for use;

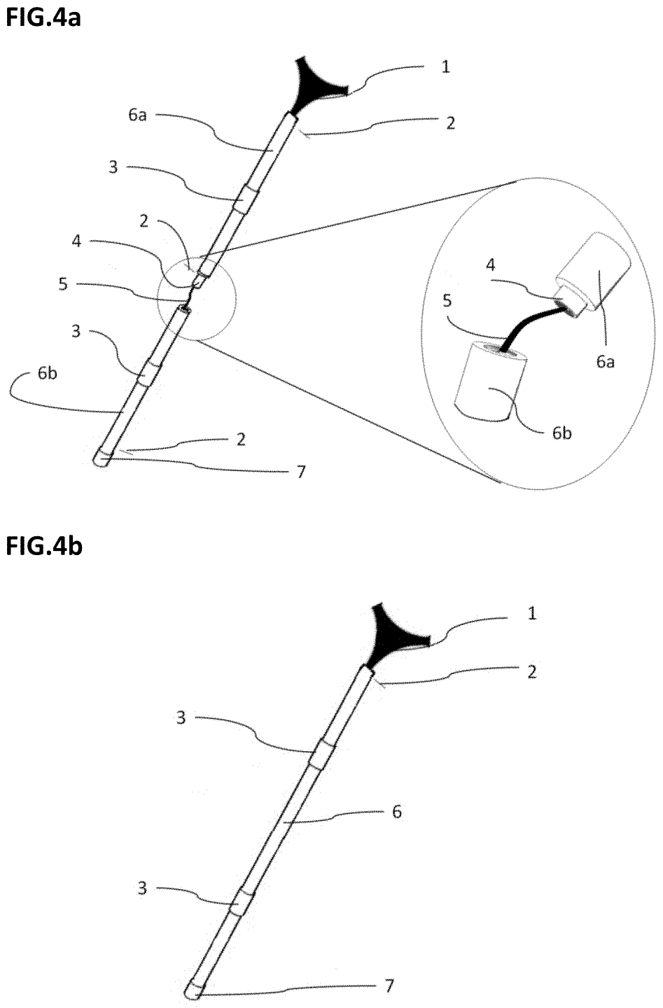

Referring to FIG. 4a and FIG. 4b the tripod leg segments (6a and 6b for the tripod version with legs made of plurality of segments or 6 for the tripod version with legs made of one segment only) are rigid and hollow;

Referring to FIG. 4a the tripod leg segments (the tripod version with legs made of plurality of segments) are connected to each other using a connector 4 coupled to the upper segment 6a and fitting by insertion into the lower hollowed segment 6b and by an elastic cord 5 attracting each segment. The elastic cord 5 is fixed at one end to the connector 4, without being limited to it, using nails 2, and, at the other end, to the end of the lower segment 6b of the leg, without being limited to it, using nails 2.

Referring to FIGS. 1a, 1b, 2a, 2b, 4a and 4b, the leg of the tripod is, without being limited, provided with, without being limited, a non-slip rubber foot tip 7;

Referring to FIGS. 1a, 1b, 2a, 2b, 4a and 4b, the tripod leg can be fitted, or not, with self-reflective tape and/or hook-and-loop fasteners 3.

1. A compact tripod as temporary marker comprising:
a flexible head coupled to a plurality of legs, all legs being similar;
a plurality of legs, each of the plurality of legs having one or plurality of segments;
a plurality of legs, each of the plurality of legs having plurality of segments are being independently foldable from a folded position to an extended position;
a plurality of legs, each of the plurality of legs having plurality of segments, each plurality of segments being coupled with the adjacent segment of the plurality of segments using a connector and, without being limited to, an elastic cord;
a plurality of feet coupled to the plurality of legs, each of the plurality of feet being coupled to a distal end of one of the plurality of legs;

2. The compact tripod as temporary marker of claim 1 further comprising a flexible head enabling legs to be brought together for a close compact position and legs to be opened for a multi-angles extended position;

3. The compact tripod as temporary marker of claim 1 further comprising of a head being made of one part or plurality of parts;

4. The compact tripod as temporary marker of claim 1 further comprising of a head being of any shape;

5. The compact tripod as temporary marker of claim 1 further comprising of a head being made of material comprising copper, plastic, rubber, aluminum or others enabling a multi-angle extended position and a compact closed position;

6. The compact tripod as temporary marker of claim 1 further comprising a plurality of legs, each of the plurality of legs having one or plurality of segments, the latter being connected using items comprising a connector and comprising, without being limited to, an elastic/bungee cord;

7. The compact tripod as temporary marker of claim 1 further comprising each of the plurality of legs being rigid, hollow or full;

8. The compact tripod as temporary marker of claim 1 further comprising each of the plurality of feet being of a comprising non-slip rubber;

9. The compact tripod as temporary marker of claim 1 further comprising of the plurality of legs being of variable length, being round or triangular or prismatic shape, and being made of a material comprising PVC, plastic, aluminum, wood or any other rigid and light material;

10. The compact tripod as temporary marker of claim 1 further comprising each of the plurality of legs being covered, or not, with material comprising adhesive tape, paint, dye, plastic coat or any covering material, giving the desired color;

11. The compact tripod as temporary marker of claim 1 further comprising each of the plurality of legs being fitted, or not, with items comprising self-reflective tape accentuating its visibility;

12. The compact tripod as temporary marker of claim 1 further comprising, or not, accessories, embedded or not, such as a hook-and-loop fasteners, a sign/panel/poster, a lamp/light/led, a rod, a security tape or the like.
